(19) United States
(12) Patent Application Publication
(10) Pub. No.: US 2019/0025966 A1
(43) Pub. Date: Jan. 24, 2019

(54) IN-CELL TOUCH DISPLAY

(71) Applicant: Wuhan China Star Optoelectronics Technology Co., Ltd., Wuhan, Hubei (CN)

(72) Inventors: Zhenzhou XING, Wuhan, Hubei (CN); Yingchi WANG, Wuhan, Hubei (CN)

(21) Appl. No.: 15/571,013

(22) PCT Filed: Oct. 19, 2017
(86) PCT No.: PCT/CN2017/106923

§ 371 Date: Oct. 31, 2017

(30) Foreign Application Priority Data
Jul. 12, 2017 (CN) 201710567079.X

(51) Int. Cl. G06F 3/041; G09G 3/20

(52) U.S. Cl. CPC G06F 3/0412; G09G 2310/0297; G09G 3/20; G06F 3/0416

(57) ABSTRACT

An In-cell type touch display is provided in the present application. The display panel of the In-cell type touch display has a plurality of multiplexing modules corresponding to the multi-column touch sensing electrodes; each of the plurality of multiplexed modules includes a plurality of thin film transistors corresponding to the plurality of touch sensing electrodes corresponding to a column of touch sensing electrodes, respectively. The drains of the plurality of thin film transistors in the same multiplexing module are electrically connected, and to electrically connected to the corresponding pins of the touch and display driver chip, gates of the thin film transistors corresponding to the same row of the touch sensing electrodes are electrically connected to the same control signal line; sources of each thin film transistor are electrically connected to the corresponding touch sensing electrodes through corresponding traces. The touch and display driver chip size can be reduced.

### FIELD OF THE DISCLOSURE

The disclosure relates to a touch technical field, and more particularly to an In-cell touch display.

### BACKGROUND

With the continuous improvement of flat panel display technology, more and more displays have equipped with a touch panel. At present, according to the working principle of the touch panel and the medium of transmission information, the touch panel can be divided into four categories, namely, resistive touch panel, capacitive touch panel, infrared touch panel and surface acoustic wave touch panel. For the capacitive touch panel, in-cell touch technology with its low cost, low power consumption, thin thickness and capable of multi-touch and other advantages, has become the mainstream in the field of touch, and become a new direction for the future development. Wherein, the display panel architecture with all the touch structure setting in the display panel (Full in cell) is increasingly becoming a standard of high-end display panel.

The architecture of full in cell display panel is most driven by using the touch and display driver IC (TDDI), Its advantages are TDDI is integrated the two functions of driving and touching in a chip at the same time, and is conducive to a high degree of integration, compared to the normal use of two independent touch chip and driver chip to drive the panel. Referring to FIG. 1, FIG. 1 shows a schematic view of a conventional In-cell type touch display. The In-cell type touch display includes a display panel 100′ and a touch and display driver chip 200′ electrically connected to the display panel 100′, wherein the display panel 100′ has a plurality of touch sensing electrodes 110′ arranged in an array, and a plurality of traces 120′ corresponding connected to the plurality of touch sensing electrodes 110′. At the same time, the touch and display driver chip 200′ is provided with a plurality of pins 210′ with the same number of the touch sensing electrodes 110′, each of the touch sensing electrodes 110′ is connected to the pins 210′ through the traces 120′, when the touch scanning is performed, the scanning is column by column inwardly from the outermost two columns of touch sensing electrodes 110′ simultaneously, until the scanning of all the touch sensing electrodes 110′ is completed. The touch and display driver chip 200′ of the In-cell type touch display has the pin 210′ as the same number of the touch sensing electrodes 110′, at the same time, it has also produced pins used for driving the panel, so that the size of a single touch and display driver chip is greatly increased, and not conducive to reducing product costs.

### SUMMARY

The object of the present application is to provide an In-cell type touch display capable of reducing the number of pins of the touch and display driver chips, reducing the size of the touch and display driver chips, and reducing the product cost.

In order to achieve the above object, the present application provides an In-cell type touch display including a display panel, and a touch and display driver chip electrically connected to the display panel.

The display panel including a plurality of touch sensing electrodes arranged in an array type, traces corresponding connected to the plurality of touch sensing electrodes, and a plurality of multiplexing module corresponding to multi-columns of the touch sensing electrodes;

Each multiplexing module including a plurality of thin film transistors corresponding to the plurality of touch sensing electrodes in a corresponding one column of the touch sensing electrodes, respectively;

The touch and display driver chip including a plurality of pins corresponding to the multi-columns of the touch sensing electrodes;

Drains of the plurality of thin film transistors in the same multiplexing module is electrically connected and electrically connected to the corresponding pins of the touch and display driver chip; gates of the thin film transistors corresponding to the same row of the touch sensing electrodes are electrically connected to the same control signal line; sources of each thin film transistor are electrically connected to the corresponding touch sensing electrodes through corresponding traces.

When the touch scanning is performed, control signals are sequentially provided to a plurality of control signal lines to turn on the thin film transistors corresponding to multi-rows of the touch sensing electrodes, to connect the touch sensing electrodes and the touch and display driver chip row by row to realize performing progressively scanning of the plurality of touch sensing electrodes.

When the touch scanning is performed, in the direction away from the touch and display driving driver chip, the control signal is sequentially provided to the plurality of control signal lines to turn on the thin film transistors corresponding to the multi-rows of the touch sensing electrodes, to connect the touch sensing electrodes and the touch and display driver chip row by row to realize performing progressively scanning of the plurality of touch sensing electrodes along the direction away from the touch and display driver chip.

The thin film transistors are N-type thin film transistors, when the touch scanning is performed, the control signal of high potential is provided to the control signal lines to turn on the corresponding thin film transistors.

The plurality of control signal lines is all electrically connected to the touch and display driver chip, the control signal is provided by the touch and display driver chip.

The touch sensing electrodes are transparent common electrodes.

The material of the touch sensing electrode is indium tin oxide.

The plurality of multiplexing modules is provided at the edges of the display panel, and disposed between the touch sensing electrodes and the touch and display driver chip.

The present application further provides an In-cell type touch display including a display panel, and a touch and display driver chip electrically connected to the display panel;

The display panel including a plurality of touch sensing electrodes arranged in an array type, traces corresponding connected to the plurality of touch sensing electrodes, and a plurality of multiplexing module corresponding to multi-columns of the touch sensing electrodes;

Each multiplexing module including a plurality of thin film transistors corresponding to the plurality of touch sensing electrodes in a corresponding one column of the touch sensing electrodes, respectively;

The touch and display driver chip including a plurality of pins corresponding to the multi-columns of the touch sensing electrodes;

Drains of the plurality of thin film transistors in the same multiplexing module is electrically connected and electrically connected to the corresponding pins of the touch and display driver chip; gates of the thin film transistors corresponding to the same row of the touch sensing electrodes are electrically connected to the same control signal line; sources of each thin film transistor are electrically connected to the corresponding touch sensing electrodes through corresponding traces;

Wherein when the touch scanning is performed, control signals are sequentially provided to a plurality of control signal lines to turn on the thin film transistors corresponding to multi-rows of the touch sensing electrodes, to connect the touch sensing electrodes and the touch and display driver chip row by row to realize performing progressively scanning of the plurality of touch sensing electrodes;

Wherein when the touch scanning is performed, in the direction away from the touch and display driving driver chip, the control signal is sequentially provided to the plurality of control signal lines to turn on the thin film transistors corresponding to the multi-rows of the touch sensing electrodes, to connect the touch sensing electrodes and the touch and display driver chip row by row to realize performing progressively scanning of the plurality of touch sensing electrodes along the direction away from the touch and display driver chip; wherein the touch sensing electrodes are transparent common electrodes;

Wherein the plurality of multiplexing modules is provided at the edges of the display panel, and disposed between the touch sensing electrodes and the touch and display driver chip.

The advantageous effects of the application: The In-cell type touch display provided by the application has a plurality of multiplexing modules arranged in the display panel corresponding to the multi-column touch sensing electrodes, each of the plurality of multiplexed modules includes a plurality of thin film transistors corresponding to the plurality of touch sensing electrodes corresponding to a column of touch sensing electrodes, respectively. The drains of the plurality of thin film transistors in the same multiplexing module are electrically connected, and to electrically connected to the corresponding pins of the touch and display driver chip, gates of the thin film transistors corresponding to the same row of the touch sensing electrodes are electrically connected to the same control signal line; sources of each thin film transistor is electrically connected to the corresponding touch sensing electrodes through the corresponding traces. So that the touch and display driver chip only need to be provided with the same number of pins as the number of columns of the touch sensing electrode to realize the touch function, the number of pins of the touch and display driver chip can be effectively reduced, the size of the touch and display driver chip can be reduced, and reduce the product cost.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a schematic diagram of a conventional In-cell type touch display; and

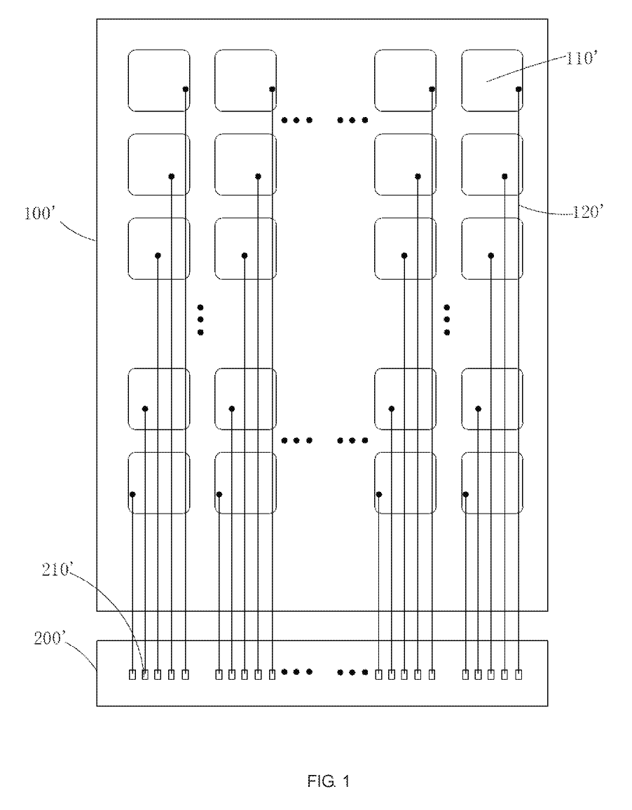

FIG. 2 is a schematic diagram of an In-cell type touch display according to the present application.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”; “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The disclosure will be further described in detail with reference to accompanying drawings and preferred embodiments as follows.

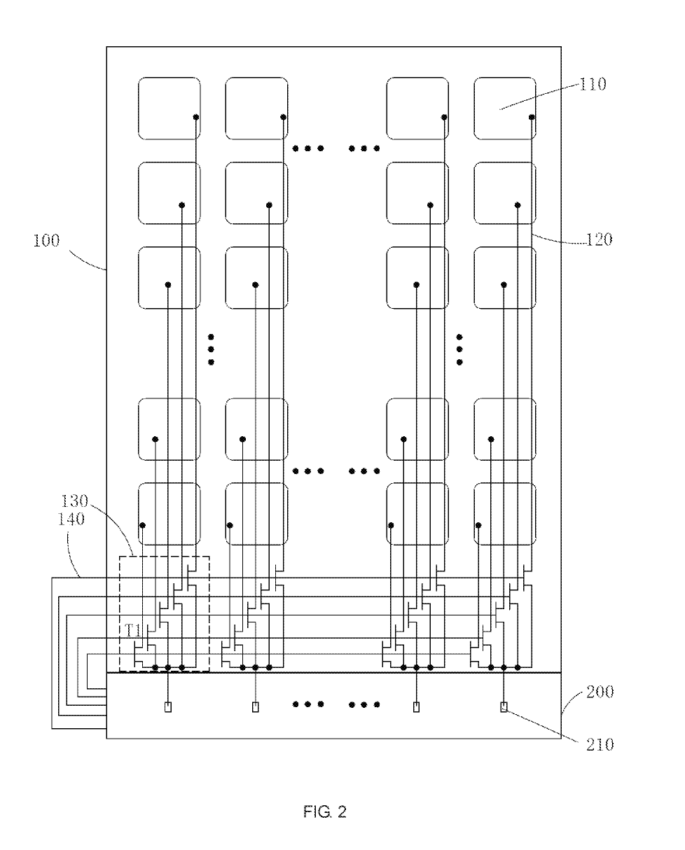

Referring to FIG. 2, the present application provides an In-cell type touch display, including a display panel 100, and a touch and display driver chip 200 electrically connected to the display panel 100;

The display panel 100 has a plurality of touch sensing electrodes 110 arranged in an array, traces 120 corresponding connected to the plurality of touch sensing electrodes 110, and a plurality of multiplexing module 130 corresponding to the multi-columns of the touch sensing electrodes 120.

Each multiplexing module 130 includes a plurality of thin film transistors T1 corresponding to the plurality of touch sensing electrodes 110 in a corresponding one column of the touch sensing electrodes 110, respectively;

The touch and display driver chip 200 has a plurality of pins 210 corresponding to the multi-column of the touch sensing electrodes 110;

Drains of the plurality of thin film transistors T1 in the same multiplexing module 130 is electrically connected and electrically connected to the corresponding pins 210 of the touch and display driver chip 200; gates of the thin film transistors T1 corresponding to the same row of the touch sensing electrodes 110 are electrically connected to the same control signal line 140; sources of each thin film transistor T1 are electrically connected to the corresponding touch sensing electrodes 110 through the corresponding traces 120.

Specifically, when the touch scanning is performed, the control signal is sequentially provided to the plurality of control signal lines 140 to turn on the thin film transistors T1 corresponding to the multi-rows of the touch sensing electrodes 110, to connect the touch sensing electrodes 110 and the touch and display driver chip 200 row by row to realize performing progressively scanning of the plurality of touch sensing electrodes 110.

Preferably, when the touch scanning is performed, in the direction away from the touch and display driving driver chip 200, the control signal is sequentially provided to the plurality of control signal lines 140 to turn on the thin film transistors T1 corresponding to the multi-rows of the touch sensing electrodes 110, to connect the touch sensing electrodes 110 and the touch and display driver chip 200 row by row to realize performing progressively scanning of the plurality of touch sensing electrodes 110 along the direction away from the touch and display driver chip 200.

Specifically, the thin film transistors T1 may be N-type thin film transistors, when the touch scanning is performed, the control signal of high potential is provided to the control signal lines 140 to turn on the corresponding thin film transistors T1. Of course, the thin film transistors T1 may be P-type thin film transistors, correspondingly when performing the touch scanning, the control signal of low potential is provided to the control signal lines 140 to turn on the corresponding thin film transistors T1.

In particular, the plurality of control signal lines 140 are all electrically connected to the touch and display driver chip 200, the control signal is provided by the touch and display driver chip 200.

In particular, the touch sensing electrodes 110 are transparent common electrodes in the conventional display panel structure. Preferably, the material of the touch sensing electrode 110 is indium tin oxide.

In particular, the plurality of multiplexing modules 130 is provided at the edges of the display panel 100, and disposed between the touch sensing electrodes 110 and the touch and display driver chip 200.

It should be noted that, the present application is provided with a plurality of multiplexing modules 130, a column of touch sensing electrodes 110 is connected to one pin of the touch and display driver chip 200 by using the multiplexing modules 130, so that the touch and display driver chip 200 only needs to be provided with the same number of pins 210 as the number of columns of the touch sensing electrode 110. When the touch scanning is performed, the plurality of control signal lines 140 are used to turn on the thin film transistor T1, that is the touch sensing electrodes 110 are connected to the touch and display driver chip 200 row by row to capable of realizing to perform progressive scanning row by row of the plurality of touch sensing electrodes 110, to realize the touch function of the In-cell type touch display, the number of pins 210 of the touch and display driver chip 200 can be effectively reduced, the size of the touch and display driver chip 200 can be reduced, and reduce the product cost.

In view of the above, the In-cell type touch display of the present application has a plurality of multiplexing modules arranged in the display panel corresponding to the multi-column touch sensing electrodes, each of the plurality of multiplexed modules includes a plurality of thin film transistors corresponding to the plurality of touch sensing electrodes corresponding to a column of touch sensing electrodes, respectively. The drains of the plurality of thin film transistors in the same multiplexing module are electrically connected, and to electrically connected to the corresponding pins of the touch and display driver chip, gates of the thin film transistors corresponding to the same row of the touch sensing electrodes are electrically connected to the same control signal line; sources of each thin film transistor are electrically connected to the corresponding touch sensing electrodes through the corresponding traces. So that the touch and display driver chip only need to be provided with the same number of pins as the number of columns of the touch sensing electrode to realize the touch function, the number of pins of the touch and display driver chip can be effectively reduced, the size of the touch and display driver chip can be reduced, and reduce the product cost.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. An In-cell type touch display, comprising a display panel, and a touch and display driver chip electrically connected to the display panel;
the display panel comprising a plurality of touch sensing electrodes arranged in an array type, traces corresponding connected to the plurality of touch sensing electrodes, and a plurality of multiplexing module corresponding to multi-columns of the touch sensing electrodes;
each multiplexing module comprising a plurality of thin film transistors corresponding to the plurality of touch sensing electrodes in a corresponding one column of the touch sensing electrodes, respectively;
the touch and display driver chip comprising a plurality of pins corresponding to the multi-columns of the touch sensing electrodes; and
drains of the plurality of thin film transistors in the same multiplexing module is electrically connected and electrically connected to the corresponding pins of the touch and display driver chip; gates of the thin film transistors corresponding to the same row of the touch sensing electrodes are electrically connected to the same control signal line; sources of each thin film transistor are electrically connected to the corresponding touch sensing electrodes through corresponding traces.

2. The In-cell type touch display according to claim 1, wherein when the touch scanning is performed, control signals are sequentially provided to a plurality of control signal lines to turn on the thin film transistors corresponding to multi-rows of the touch sensing electrodes, to connect the touch sensing electrodes and the touch and display driver chip row by row to realize performing progressively scanning of the plurality of touch sensing electrodes.

3. The In-cell type touch display according to claim 2, wherein when the touch scanning is performed, in the direction away from the touch and display driving driver chip, the control signals are sequentially provided to the plurality of control signal lines to turn on the thin film transistors corresponding to the multi-rows of the touch sensing electrodes, to connect the touch sensing electrodes and the touch and display driver chip row by row to realize performing progressively scanning of the plurality of touch sensing electrodes along the direction away from the touch and display driver chip.

4. The In-cell type touch display according to claim 2, wherein the thin film transistors are N-type thin film transistors, when the touch scanning is performed, the control signal of high potential is provided to the control signal lines to turn on the corresponding thin film transistors.

5. The In-cell type touch display according to claim 2, wherein the plurality of control signal lines is all electrically connected to the touch and display driver chip, the control signal is provided by the touch and display driver chip.

6. The In-cell type touch display according to claim 1, wherein the touch sensing electrodes are transparent common electrodes.

7. The In-cell type touch display according to claim 6, wherein the material of the touch sensing electrode is indium tin oxide.

8. The In-cell type touch display according to claim 1, wherein the plurality of multiplexing modules is provided at the edges of the display panel, and disposed between the touch sensing electrodes and the touch and display driver chip.

9. An In-cell type touch display, comprising a display panel, and a touch and display driver chip electrically connected to the display panel;
the display panel comprising a plurality of touch sensing electrodes arranged in an array type, traces corresponding connected to the plurality of touch sensing electrodes, and a plurality of multiplexing module corresponding to multi-columns of the touch sensing electrodes;
each multiplexing module comprising a plurality of thin film transistors corresponding to the plurality of touch sensing electrodes in a corresponding one column of the touch sensing electrodes, respectively;
the touch and display driver chip comprising a plurality of pins corresponding to the multi-columns of the touch sensing electrodes;
drains of the plurality of thin film transistors in the same multiplexing module is electrically connected and electrically connected to the corresponding pins of the touch and display driver chip; gates of the thin film transistors corresponding to the same row of the touch sensing electrodes are electrically connected to the same control signal line; sources of each thin film transistor are electrically connected to the corresponding touch sensing electrodes through corresponding traces;
wherein when the touch scanning is performed, control signals are sequentially provided to a plurality of control signal lines to turn on the thin film transistors corresponding to multi-rows of the touch sensing electrodes, to connect the touch sensing electrodes and the touch and display driver chip row by row to realize performing progressively scanning of the plurality of touch sensing electrodes;
wherein when the touch scanning is performed, in the direction away from the touch and display driving driver chip, the control signals are sequentially provided to the plurality of control signal lines to turn on the thin film transistors corresponding to the multi-rows of the touch sensing electrodes, to connect the touch sensing electrodes and the touch and display driver chip row by row to realize performing progressively scanning of the plurality of touch sensing electrodes along the direction away from the touch and display driver chip;
wherein the touch sensing electrodes are transparent common electrodes; and
wherein the plurality of multiplexing modules is provided at the edges of the display panel, and disposed between the touch sensing electrodes and the touch and display driver chip.

10. The In-cell type touch display according to claim 9, wherein the thin film transistors are N-type thin film transistors, when the touch scanning is performed, the control signal of high potential is provided to the control signal lines to turn on the corresponding thin film transistors.

11. The In-cell type touch display according to claim 9, wherein the plurality of control signal lines is all electrically connected to the touch and display driver chip, the control signal is provided by the touch and display driver chip.

12. The In-cell type touch display according to claim 9, wherein the material of the touch sensing electrode is indium tin oxide.
